(19) United States
(12) Patent Application Publication
(10) Pub. No.: US 2026/0030519 A1
(43) Pub. Date: Jan. 29, 2026

(54) SYSTEM AND METHOD FOR PREDICTING ELECTRIC VEHICLE CHARGING AND DISCHARGING

(71) Applicant: EATON INTELLIGENT POWER LIMITED, DUBLIN 4 (IE)

(72) Inventors: Adi Ionel Botea, Dublin (IE); Mahesh Atmaram Sorate, Pune (IN)

(73) Assignee: EATON INTELLIGENT POWER LIMITED, DUBLIN 4 (IE)

(21) Appl. No.: 18/783,758

(22) Filed: Jul. 25, 2024

(51) Int. Cl. G06N 5/022

(52) U.S. Cl. CPC G06N 5/022

(57) ABSTRACT

A computer-implemented method of predicting electric vehicle (EV) charging and discharging. The method includes: collecting input data from a database and a plurality of EVs authorized to be charged or discharged at a site, the input data including historical input data and real time input data associated with charging and discharging the EVs; training a plurality of machine learning (ML) models using the historical input data to predict EV charging and discharging outcomes at the site for a time period; and predicting, by an ML inference device that is applying the trained ML models to the real time input data, an amount of power needed for EV charging or an amount of EV discharging power available by the one or more authorized EVs during a time interval.

### FIELD OF THE INVENTION

The disclosed concept relates generally to electric vehicle charging system and method, more particularly, a system and method for EV charging and discharging forecasting at a site.

### BACKGROUND OF THE INVENTION

As the world transitions to sustainable and renewable energy, electric vehicles (EVs) are being adopted globally since they may reduce emission as compared to the traditional gas-powered cars. Accordingly, the demand for electric vehicle supply equipment (EVSE) has also increased significantly. An EVSE is an element in an infrastructure that supplies electric energy for the recharging of electric energy for the recharging of EVs, plug-in hybrid electric-gasoline vehicles, or semi-static and mobile electrical units such as exhibition stands. The EVSEs are installed in various facilities, e.g., without limitation, charging service stations, supermarkets, apartment buildings, hotels, convenience stores, or parking stations. Further, many corporations and entities have also introduced EV charging capabilities and installed the EVSEs in their office buildings, factories, plants, and other industrial facilities for use by their personnel.

However, the power required for EV charging is relatively large. For example, an EV may use 11.81 kWh per day for normal charging, and up to 100 kWh for quick charging, which is more than the power consumed by, e.g., a building air conditioning equipment. Hence, for a typical office building which has power receiving capacity of several hundred kWh, installation and maintaining a plurality of EVSEs pose a heavy financial burden. Such burden may be reduced by use of V2X or V2G technologies. Further, since the power supply and electricity prices from the utility grid can fluctuate depending on the time of day, attempts have been made to predict EV charging need and discharging capabilities of predefined EVs. The predefined EVs include the EVs that are authorized and/or registered to be charged and/or discharged at the charging facilities. However, accurately predicting EV charging and/or discharging at a charging facility is very difficult due to the high levels of noise that often characterize EV charging and discharging patterns. For example, due to the normalization of remote working conditions, the arrivals and departures of the registered EVs at an office building are virtually stochastic, rendering the accurate forecasting of the EV charging and discharging onsite at a given time period extremely difficult.

There is room for improvement in EV charging system.

There is room for forecasting EV charging and discharging at a site.

### SUMMARY OF THE INVENTION

These needs, and others, are met by a computer-implemented method of predicting electric vehicle (EV) charging and discharging. The method includes: collecting input data from a database and a plurality of EVs authorized to be charged or discharged at a site, the input data including historical input data and real time input data associated with charging and discharging the EVs; training a plurality of machine learning (ML) models using the historical input data to predict EV charging and discharging outcomes at the site for a time period; and predicting, by an ML inference device that is applying the trained ML models to the real time input data, an amount of power needed for EV charging or an amount of EV discharging power available by the one or more authorized EVs during a time interval.

Another exemplary embodiment provides an EV charging and discharging prediction system for use at a site having EV chargers and connected to databases and a cloud server hosting application programming interfaces (APIs) structured to ingest data from the databases and output input data. The system includes: an ML training device including ML models and a retraining device, the ML models structured to be trained using historical input data received from first APIs to perform EV charging and discharging prediction at the site for a time period, the retraining device structured to continuously retrain the trained ML models; a model store structured to store at least the trained ML models; an ML inference device structured to apply the trained ML models to real time data input received from the first APIs and predict that one or more authorized EVs are to arrive at the site for a time period and also predict an amount of EV charging power needed or an amount of EV discharging power available by the one or more authorized EVs for a time interval based on the real time input data and the historical input data; and an insights data store structured to store insights derived from inferences, feed the insights to the ML training device for retraining, and transmit the insights to second APIs for optimization of energy trading and energy management control for the site.

### BRIEF DESCRIPTION OF THE DRAWINGS

A full understanding of the invention can be gained from the following description of the preferred embodiments when read in conjunction with the accompanying drawings in which:

FIG. 1 is a diagram of an exemplary energy distribution system in accordance with a non-limiting, exemplary embodiment of the disclosed concept;

FIG. 2 is a block diagram of an exemplary EV charging and discharging predicting system in accordance with a non-limiting, exemplary embodiment of the disclosed concept;

FIG. 3 is a block diagram of the EV charging and discharging predicting system of FIG. 2; and

FIG. 4 is a flow chart for a method of predicting EV charging and discharging at a site in accordance with a non-limiting, exemplary embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

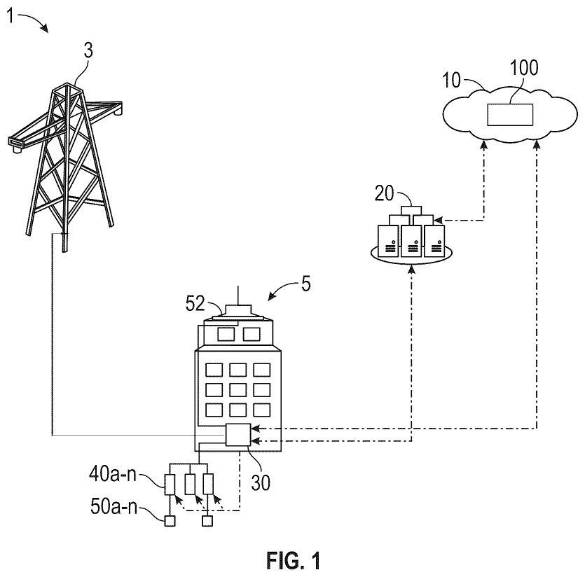

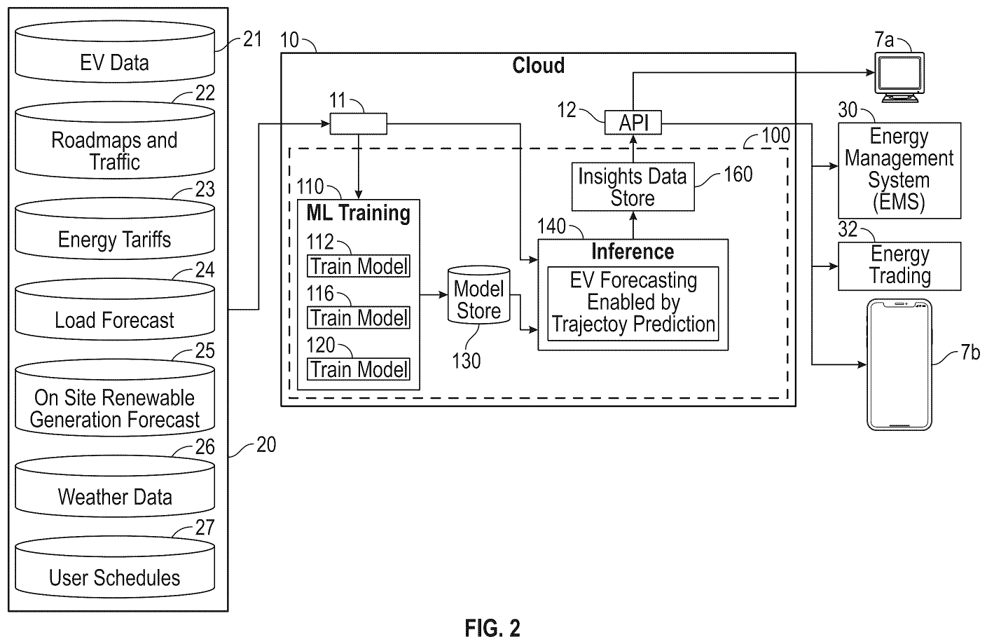

FIG. 1 is a diagram of an exemplary energy distribution system 1 in accordance with a non-limiting, exemplary embodiment of the disclosed concept. The energy distribution system 1 includes utility grid 3, a facility (e.g., without limitation, a building, a plant or equipment storage) 5, a cloud server 10, and databases (e.g., without limitation, local or cloud database servers) 20. The building 5 may be an office building and includes an energy management system (EMS) 30, EVSEs 40a-n (n being a positive integer), distributed energy resources (DERs) and loads. The loads may include, e.g., without limitation, lighting, HVACs, office equipment or the EVs 50a-n. The DERs include, e.g., without limitation, batteries, the EVs 50a-n, photovoltaics (PVs) 52, etc. The DERs, the building 5 and the loads form a microgrid which operates in the grid-connected mode when it is connected to the grid 3 and in the islanded mode when it is disconnected from the grid 3 (e.g., without limitation, a power outage or planned islanding). During the grid-connected mode, the DERs may share their excess powers to the grid 3 and during the islanded mode, the DERs may provide power to the loads. The EVSEs 40a-n are connected to the EMS 30 and supplies power to the EVs 50a-n (upon connecting to the EVs 50a-n) from the grid 3 or other DERs. The EVs 50a-n can consume grid power or supply power to the grid 3 (V2G) during the grid-connected mode or supply power to the loads (V2X) during the islanded mode. As such, the EVs can be a load or DER depending on their battery levels. An EMS 30 includes a device (a hardware combined with software) structured to optimally distribute energy flows between connected DERs. The EMS 30 collects, analyzes and visualizes energy data in real time and dynamically controls energy flows between the connected DERs. The energy distribution system 1 may also include an energy trading system (ETS) 32 as shown in FIG. 2. The ETS 32 may be a standalone device or included within the EMS 30 and structured to monitor and control energy trading between the DERs and/or the grid 3.

The cloud server 10 may be a cloud infrastructure such as Azure®, AWS® or Google Cloud®, which provide cloud-based computing resources. The cloud server 10 is communicatively connected to the databases 20, the EMS 30, the ETS 32 or remote user devices 7a, 7b communicatively coupled to the cloud 10 via the APIs 12 (as shown in FIG. 2). The cloud server 10 may include an EV charging and discharging prediction system 100, first APIs 11 and second APIs 12 as shown in FIG. 2. The APIs 11, 12 may be hosted or included within the cloud server 10 and be structured to ingest the data received from the databases 20. For example, the first APIs 11 collect and process the data (historical and real time) and feed the processed data to the models 112-122 of the ML training device 110 and the ML inference device 140 of the EV charging and discharging prediction system 100. The ML training device 110 trains a plurality of models 112-122 using the historical data to predict EV charging and discharging at the site 5 at a given time interval. The ML inference device 140 receives real time data from the first APIs 11, applies the trained models 112-122 to the real time data, and predict individual and aggregate EV charging and discharging amounts at the site 5 during a given time interval. The second APIs 12 are connected to an insights data store 160, the EMS 30, the ETS 32 and user devices 7a, 7b (as shown in FIG. 2) and receive the inference results and insights derived from the insights data store 160 and allow the DERs and EVSEs 40a-n to communicate and exchange data seamlessly, automate tasks (e.g., without limitation, battery storage), and enable the building 5 to optimize energy usage, e.g., without limitation, during off-peak hours. For example, the building administrators may upload the EMS or ETS applications on their user devices (e.g., without limitation, a laptop computer 7a, a mobile phone 7b as shown in FIG. 2), which communicate with backend systems such as the EMS 30, ETS 32 or the DERs via the second APIs 12. That is, through the EMS or ETS apps on the user devices 7a, 7b, the building administrator can monitor energy consumption and perform energy trading and energy management control remotely and real-time via the second APIs 12. Based on the inference results and insights, the energy trading and energy management control is optimized by enabling the EMS 30 and the ETS 32 to determine the optimal times to block purchase energy to be used to charge one or more EVs 50a-n, to use locally-generated solar energy or the EV batteries or draw power from the grid 3.

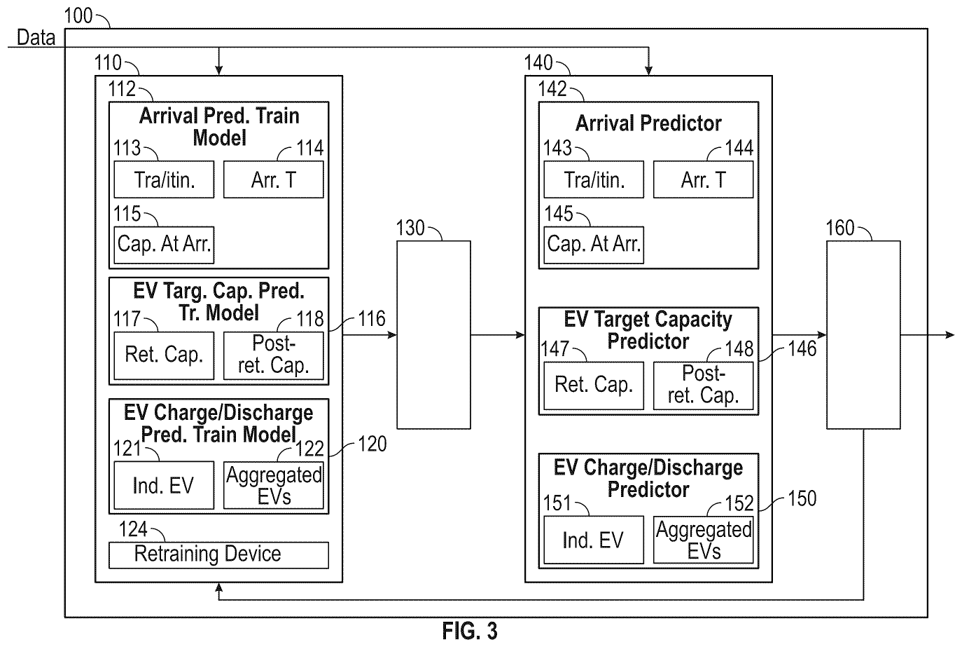

The databases 20 may include servers, storage devices and networking equipment. In a preferred embodiment, the databases 20 are housed in data stores. The databases 20 receive data from a plurality of data sources via the networking equipment, process the data via the servers, store the processed data in the storage devices, and transmit the processed data to the EV charging and discharging prediction system 100. The plurality of data sources include, e.g., without limitation, government database, financial and economic database, image database, weather database, traffic database, vehicle database and/or the user schedules (e.g., without limitation, calendars). The data include, e.g., without limitation, EV data 21, roadmaps and traffic data (current and forecast) 22, energy tariff data 23, load forecast data 24, on site renewable generation forecast data 25, weather data (current and forecast) 26 and EV user schedule data 27. Optionally, the data may be provided directly from the EVs 50a-n. The data 21-27 are discussed further with reference to FIG. 3. The historical data are fed to the ML training device 110 for training the models and the new and real time data are fed to the ML inference device 140 for predicting the EV charging and discharging at the site 5 during a given time interval.

FIG. 2 illustrates a block diagram of an exemplary EV charging and discharging prediction system 100 in accordance with a non-limiting, exemplary embodiment of the disclosed concept. While FIG. 2 shows that the cloud server 10 includes the EV charging and discharging prediction system 100, the EV charging and discharging prediction system 100 may be a local machine learning system disposed within a local server of the building 5 or distributed machine learning system over a plurality of cloud servers as appropriate without departing from the scope of the disclosed concept. The EV charging and discharging prediction system 100 includes a machine learning (ML) training device 110, a model store 130, an ML inference device 140, and an insights data store 160.

The ML training device 110 may be a training server including hardware infrastructure (e.g., without limitation, CPUs, GPUs (Graphics Processing Units of Nvidia®), TPUs (Tensor Processing Unit of Google®), AIUs (artificial intelligence unit of IBM®), etc.)) structured to handle computational load during the training, software stack (e.g., without limitation, deep learning frameworks for building and training neural networks, data processing tools, model optimization algorithms such as gradient descent, and training scripts), and storage. The ML training device 110 receives historical input data from the first APIs 11 and includes models 112-122 structured to be trained using the historical input data. The models 112-122 are structured to be trained to predict whether one or more relevant EVs 50a-n in motion will arrive at the site 5, EV charging and discharging at the site 5 by the one or more relevant EVs 50a-n, and power for charging the one or more EVs 50a-n as a group, if needed. Each model 112-122 is discussed further in detail with reference to FIG. 3. The ML training device 110 also includes a retraining device 121. The retraining device 121 may include, e.g., without limitation, a retraining software structured to retrain the trained models 112-122 with the new data used by the ML inference device 140, inference results and the insights gained from the inferences.

The model store 130 is structured to store the trained models 112-122, related model artifacts (e.g., without limitation, model weights, parameters, architectures, metadata, etc.), training data and progress, and evaluation metrics. The model store 130 maintains a model registry, keeps track of model versions, and monitors the trained models 112-122.

The ML inference device 140 may be an inference server and include hardware infrastructure (e.g., without limitation, CPUs, GPUs, TPUs, AIUs, etc.) structured to handle computational load during the inferencing, software stack (e.g., without limitation, deep learning frameworks for applying the trained models to the new data, data processing tools, model optimization techniques such as model quantization, pruning, or knowledge distillation), and storage. The ML inference device 140 is structured to receive real time data (i.e., new data) from the databases 20 via the APIs 12, apply the trained ML models 112-122 retrieved from the model store 130 to the new data and predict whether one or more EVs 50a-n in motion will arrive at the site 5, EV charging and discharging at the site 5 by the one or more EVs 50a-n, and power for charging the one or more EVs 50a-n as a group, if needed.

The insights data store 160 is structured to receive and store the inference results and insights derived from the inferences. It is further structured to feed back the new data, the inference results and the insights to the ML training 110 for retraining, and transmit the inference results and the insights to the second APIs 12.

FIG. 3 is a block diagram of the EV charging and discharging prediction system 100 in accordance with a non-limiting, example embodiment of the disclosed concept. The EV charging and discharging prediction system 100 includes machine learning (ML) training device 110, a model store 130, an inference device 150 and insights data store 160. The EV charging and discharging prediction system 100 receives input data from the first APIs 11. The first APIs 11 are structured to ingest the data from the databases 20. The data from the databases 20 include, e.g., without limitation, the EV data 21, the roadmaps and traffic data (current and forecast) 22, the energy tariff data 23, the load forecast data 24, the onsite renewable generation forecast data 25, the weather data (current and forecast) 26 and the EV user schedule data 27.

The EV data 21 include sensor data, GPS data, vehicle data and user data. The sensor data include data from cameras, LiDAR, radar or ultrasonic sensors disposed on or within the EVs 50a-n. The GPS data include data from GPS for determining location, speed and direction of the EV 50a-n. The vehicle data include data from the EV's onboard systems such as the battery, motor or braking system. The user data include, e.g., without limitation, driving preferences, habits, etc. The roadmaps and traffic data 22 include high-definition maps, detailed information about the road network, lane markings, traffic lights and signs, obstacles and construction zones, and road conditions for the routes the EV user has taken or is taking currently. The energy tariff data 23 include, e.g., without limitation, a list of historical and real-time prices and charges for using the electricity. An energy tariff has different prices for using the energy at different times of the day or in different amounts. The load forecast data 24 includes a prediction of the future demand for electricity by the loads and/or the EV 50a-n. For example, the building administrator may use the load forecast data to ensure the building 5 has sufficient power and, e.g., without limitation, EVSEs 40a-n for charging the one or more EVs 50a-n in the near future. The onsite renewable generation forecast data include forecast data for the amount of electricity that the DERs will generate in the near future and help with planning and optimizing energy needs and usage. The weather data 26 include historical, real time or forecast weather conditions that can affect the performance of the EV 50a-n. The EV user schedule data 27 include user's meeting calendar, travel schedules or any other relevant mobility schedules. For example, the schedule data may include, e.g., without limitation, hot-desk bookings, emails and others that may help in predicting if one or more EVs 50a-n will arrive at the site 5 on a specific date (e.g., the next day). This can be used for an earlier forecasting (e.g., one day in advance) of the EV arrivals at the site.

The ML training device 110 includes ML models 112-122 and a retraining device 124. The ML models include an arrival prediction model 112, an EV target capacity prediction model 116 and an EV charging and discharging prediction model 120. The arrival prediction model 112 is structured to be trained using a first historical input data (e.g., without limitation, the EV data 21, the user schedule data 27, etc.) to predict whether a relevant EV 50a-n in motion (also referred to as the EV 50a-n at issue) will arrive at the site 5 (e.g., without limitation, the office building 5). The relevant EVs 50a-n in motion are EV 50a-n registered and/or authorized to charge or discharge at the site 5. The arrival prediction model 112 includes a trajectory prediction model 113 structured to be trained to predict the trajectory of the EV 50a-n in motion. The trajectory prediction model 113 is structured to be trained using, e.g., a trip plan recognition technique. That is, the model 113 is trained on historical trips made by the EV 50a-n in motion. The trajectory prediction model 113 is further trained to determine whether the EV 50a-n in motion is advancing towards the site 5 or not and outputs a binary variable indicating the determination. In response to determining that the EV 50a-n in motion is advancing towards the site 5, the arrival time prediction model 114 is structured to be trained to predict the arrival time of the EV 50a-n in motion at the site 5 by computing an estimated arrival time of the EV 50a-n at issue based on a second historical input data, which include historical EV data, roadmap and traffic data 22 and weather data 26. Based on the predicted arrival time, the EV capacity-at-arrival prediction model 115 is structured to be trained to predict the EV capacity-at-arrival of the EV 50a-n at issue. The EV capacity-at-arrival is the battery level of the EV 50a-n at issue upon arriving the site 5.

The ML training device 110 further includes an EV target capacity prediction model 116, which is structured to be trained to predict the EV target capacity at departure from the site 5. The EV target capacity at departure is the battery level of the EV 50a-n at issue at the time of its departure from the site 5. The EV target capacity prediction model 116 includes a return trip target capacity prediction model 117 and a post-return-trip capacity prediction model 118. The return trip target capacity prediction model 117 is structured to be trained to predict the return trip target capacity of the EV 50a-n at issue, using a third historical input data. The third historical input data include the EV data 21 (e.g., without limitations, the site location, the return destination (e.g., without limitation, home address), historical charge usage data for a return trip home for the EV 50a-n at issue, etc.). Optionally, the third historical input data may also include weather data 26. Optionally, the third historical input data may also include traffic data 22. The post-return-trip capacity prediction model 118 is structured to be trained to predict the post-return-trip capacity of the EV 50a-n at issue using the third historical input data. The post-return-trip capacity is predicted for the EV user's home energy management. For example, a given EV 50a-n may have a target capacity that allows the EV 50a-n to arrive home, and then use part of the remaining capacity to power the home and help reduce the house load at the peak time.

The ML training device 110 further includes an EV charging and discharging prediction model 120, which is structured to be trained to predict individual and aggregate EV charging and discharging at the site 5 during a time interval (e.g., without limitation, hours, a day, etc.). The time interval may be a period during which the EV 50a-n at issue stays at the site 5 or a period during which the EV 50a-n at issue is to be charged or discharged based on the predicted arrival time, energy tariffs, etc. The EV charging and discharging prediction model 120 includes an individual EV charging and discharging prediction model 121 and an aggregated EV charging and discharging prediction model 122. The individual EV charging and discharging prediction model 121 is structured to be trained to predict whether the individual EV 50a-n at issue will charge or discharge at the site 5 upon its arrival. It is further structured to be trained to predict the corresponding amount of the EV charging or discharging by the individual EV 50a-n at issue. The individual EV charging and discharging prediction model 121 is trained using a fourth historical input including the historical data associated with the EV 50a-n at issue. The aggregated EV charging and discharging prediction model 122 is structured to be trained to aggregate the individual EV charging and discharging amounts during a given time interval (e.g., without limitation, hours, a day, etc.) into an overall amount computed as the difference between the sum of all predicted individual EV charging amounts during the time interval and the sum of all predicted individual EV discharging amounts during the time interval. If the difference is positive, then the EVs 50a-n predicted to arrive at the site 5 will require power to charge, and if it is negative, the EVs 50a-n will provide power to the loads of the site 5. As such, the aggregated EV charging and discharging prediction model 122 is trained to predict an overall amount of power for charging the EVs 50a-n for the time interval, if needed (i.e., the difference is positive).

The ML training device 110 also includes a retraining device 124. The retraining device 124 includes, e.g., without limitation, a retraining software structured to retrain the trained models 112-122 with the new data (current and real time data) used by the ML inference device 140 and the insights gained from the inferences including the inference outcomes.

The model store 130 is structured to store the trained models 112-122, related model artifacts (e.g., without limitation, model weights, parameters, architectures, metadata, etc.), training data and progress, and evaluation metrics. The model store 130 maintains a model registry, keeps track of model versions, and monitors the models 112-122.

The ML inference device 140 is structured to receive real time data (i.e., new data) from the databases 20 via the first APIs 11, apply the trained ML models 112-122 retrieved from the model store 130 to the new data and predict the EV charging and discharging during a given time interval at the site 5. The ML inference device 140 includes an arrival predictor 142, an EV target capacity predictor 146 and an EV charging and discharging predictor 150. The arrival predictor 142, the EV target capacity predictor 146 and the EV charging and discharging predictor 150 each are structured to apply the corresponding trained models 112, 116, 120 to the new data. The arrival predictor 142 is structured to apply the trained arrival prediction train model 112 to a first new input data (e.g., without limitation, the EV data 21, the user schedule data 27, etc.) to predict whether a relevant EV 50a-n in motion (also referred to as the EV 50a-n at issue) will arrive at the site 5. The arrival predictor 142 includes a trajectory predictor 143, an arrival time predictor 144 and an EV capacity-at-arrival predictor 145. The trajectory predictor 143 is structured to predict the trajectory of the EV 50a-n in motion. As such, the first new input data to the trajectory predictor 143 include the first leg of the current trip in progress and a roadmap. The first leg illustrates the trajectory of the EV 50a-n in motion from the inception of the trip to the current point in time. The trajectory predictor 143 is further structured to determine whether the EV 50a-n in motion is advancing towards the site 5 or not and output a binary variable indicating the determination. In response to determining that the EV 50a-n in motion is advancing towards the site 5, the arrival time predictor 144 is structured to predict the arrival time of the EV 50a-n in motion at the site 5 by computing an estimated arrival time of the EV 50a-n at issue based on a second new input data, which include the current location 21 of the EV 50a-n at issue, the destination (site address) 21 of the EV 50a-n, roadmap data 22 and optionally, current or forecast traffic data 22 and current or forecast weather data 26. Based on the predicted arrival time, the EV capacity-at-arrival predictor 145 is structured to predict the EV capacity at arrival of the EV 50a-n at issue. The EV capacity-at-arrival is the battery level of the EV 50a-n at issue upon arriving the site 5 and indicated as the difference between the current battery level at the end of the first leg and the estimated use of the battery during the remaining trip to the site 5 based at least in part on the trip plan computed and optionally traffic data 22 and/or weather data 26.

The ML inference device 140 further includes an EV target capacity predictor 146 structured to predict the EV target capacity at departure from the site 5. The EV target capacity at departure is the battery level of the EV 50a-n at issue at the time of its departure from the site 5. The EV target capacity predictor 146 includes a return trip target capacity predictor 147 and a post-return-trip capacity predictor 148. The return trip target capacity predictor 147 is structured to predict the return trip target capacity of the EV 50a-n at issue, using a third new input data. The third new input data include the EV data 21 (e.g., without limitations, the site location, the return destination (e.g., without limitation, home address), etc.). Optionally, the third new input data may also include the current and forecast weather data 26. Optionally, the third new input data may also include current and forecast traffic data 22. The post-return-trip capacity predictor 148 is structured to predict the post-return-trip capacity of the EV 50a-n at issue using the third new input data. The post-return-trip capacity is predicted for the EV user's home energy management.

The ML inference device 140 further includes an EV charging and discharging predictor 150 structured to predict individual and aggregate EV charging and discharging at the site 5 during a given time interval (e.g., without limitation, hours, a day, etc.). The time interval may be a period during which the EV 50a-n at issue stays at the site 5 or a period during which the EV 50a-n at issue is to be charged or discharged based on the predicted arrival time, energy tariffs, etc. The EV charging and discharging predictor 150 includes an individual EV charging and discharging predictor 151 and an aggregated EV charging and discharging predictor 152. The individual EV charging and discharging predictor 151 is structured to predict whether the individual EV 50a-n at issue will charge or discharge at the site 5 upon its arrival. It is further structured to predict the corresponding amount of the EV charging or discharging by the individual EV 50a-n at issue. The individual EV charging and discharging predictor 151 predicts individual EV charging and discharging amount of the EV 50a-n at issue, using a fourth new input including the EV data 21 and corresponding historical data of the EV 50a-n at issue. The aggregated EV charging and discharging predictor 152 is structured to aggregate the individual EV charging and discharging amounts into an overall amount computed as the difference between the sum of all predicted individual EV charging amounts and the sum of all predicted individual EV discharging amounts. If the difference is positive, then the EVs 50a-n predicted to arrive at the site 5 will require power to charge, and if it is negative, the EVs 50a-n will provide power to the loads of the site 5. As such, the aggregated EV charging and discharging predictor 152 is structured to predict an overall amount of EV charging needed for a given time interval (e.g., without limitation, hours, a day, etc.) in response to predicting that the EVs 50a-n as a group will require charging at the site 5 based on the positive difference computed. As such, the aggregated EV charging and discharging predictor 152 is structured to predict an overall amount of power for charging EVs 50a-n during a given time interval (e.g., without limitation, hours, a day, etc.), if needed.

The insights data store 160 is structured to receive and store the insights derived from the inferences including the inference outcomes, feed the new data and the insights to the ML training 110 for retraining, transmit the insights to the second APIs 12 to enable optimization of energy trading and energy management control of the ETS 32 and the EMS 30.

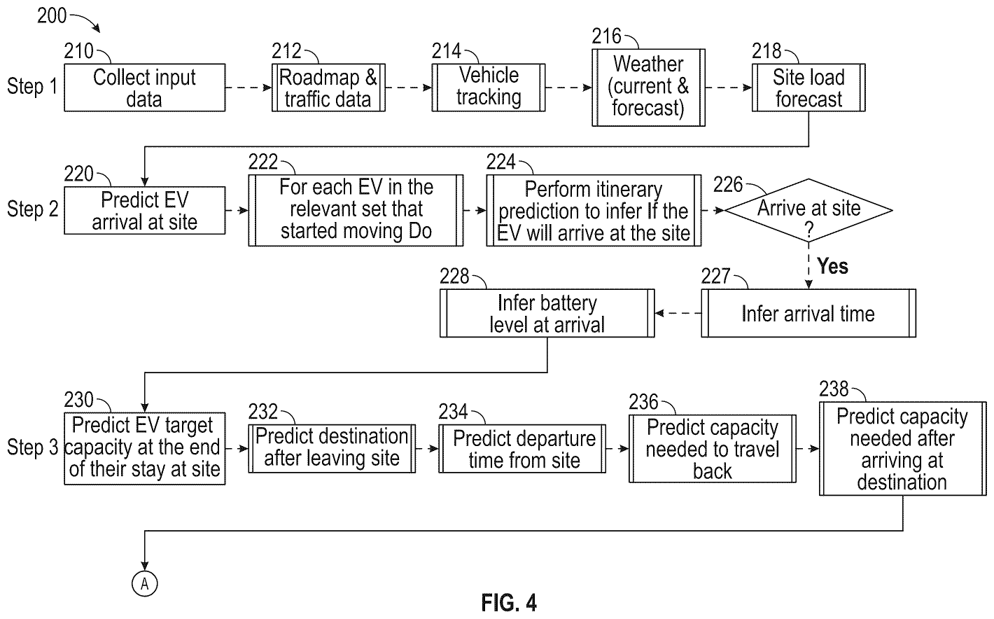

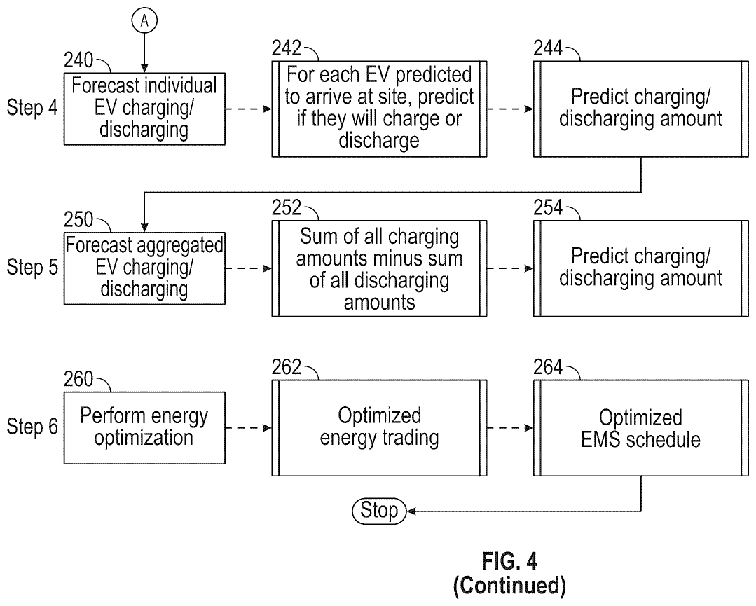

FIG. 4 illustrates a flow chart for a method 200 of predicting EV charging and discharging at a site 5 in accordance with a non-limiting, exemplary embodiment of the disclosed concept. The method 200 may be performed by the energy distribution system 1 or any components thereof. The method 200 includes six main steps 210-260 and corresponding substeps for each main step.

At step 210, the EV charging and discharging prediction system collects input data from the databases and/or EVs via the APIs. At substep 212, the EV charging and discharging prediction system receives the roadmap and traffic data from the databases. At substep 214, the EV charging and discharging prediction system receives EV data including vehicle dynamic locations and battery levels) from the databases and/or the EV. At substep 216, the EV charging and discharging prediction system receives the current and forecast weather data from the databases. At substep 218, the EV charging and discharging prediction system receives site load renewable generation forecasts from the databases.

At step 220, the arrival predictor of the ML inference device predicts EV arrival at the site (e.g., without limitation, a building). At substep 222, the arrival predictor is activated for each EV in the relevant set (e.g., a list of EVs registered or authorized to charge and/or discharge at the site), that is moving. At 224, the arrival predictor performs real time trajectory prediction (itinerary prediction) of the EV in motion. At substep 226, the arrival predictor determines whether the EV in motion will arrive at site. That is, the arrival predictor outputs, e.g., without limitation, a binary variable indicating whether the EV at hand is headed towards the site or not. If yes, at substep 227, the arrival predictor infers the arrival time of the EV. That is, the arrival predictor computes an estimated arrival time at the site using, e.g., without limitation, a trip planner. The arrival predictor takes as input the current location of the EV, the destination (site address), roadmap data and optionally traffic data. If no, the arrival predictor discards the real time input and terminates further inferences. At substep 228, the arrival predictor infers the battery level of the EV at its arrival at the site. The inferred battery level at arrival may be computed as the difference between the current level and estimated use in the rest of the trip at hand based on the trip planner. Optionally, the battery level at arrival may be computed based on real time traffic data and/or weather data. Optionally, the arrival predictor may predict if an EV(s) will arrive at the site on a specific date in the future utilizing the user data of the EV drivers such as hot-desk bookings, emails and others. This can be used for an earlier arrival forecasting (e.g., without limitation, one day in advance).

At step 230, the EV target capacity predictor the ML inference device predicts for each EV the target battery level at its departure time from the site. At substep 232, the EV target capacity predictor predicts the destination of the EV upon its departure from the site. At substep 234, the EV target capacity predictor predicts departure time from the site based on the user's schedule, calendar, or preference or habit data. At substep 236, the EV target capacity predictor predicts the battery charge capacity needed for the EV to reach the destination. The target battery level at the time of leaving the site is predicted with an EV target capacity prediction model trained for each EV on historical data corresponding to that EV. In a preferred embodiment, this is a deep learning model. Input to the model includes the site location, the destination, optionally weather data and optionally traffic data based on, e.g., without limitation, the EV data, weather, traffic and/or roadmap data. At substep 238, the EV target capacity predictor predicts the charge capacity needed for the EV after arriving at the return destination. For example, a given EV may have a target capacity that allows the EV to arrive home of the EV driver (e.g., an employee), and then use part of the remaining capacity to power the home and help reduce the house load at the peak time.

At step 240, the individual EV charging and discharging predictor predicts whether individual EVs will be charged or discharged at the site during a time interval (e.g., without limitation, hours, a day, etc.). At substep 242, the individual EV charging and discharging predictor determines if each EV predicted to arrive at the site will need to be charged or able to be discharged. At substep 244, the individual EV charging and discharging predictor predicts the charging or the discharging amount of each individual EV predicted to arrive at the site. This step can be implemented by training an individual EV charging and discharging prediction train model for each EV on historical data. In a preferred embodiment, the output of the trained model can be adjusted with the actual battery level at the arrival (computed at Step 2) and the target battery level at the departure time (computed at Step 3).

At step 250, the aggregated EVs charging and discharging predictor predicts the aggregated EV charging and discharging at the site during a time interval (e.g., without limitation, hours, a day, etc.). At substep 252, the aggregated EVs charging and discharging predictor aggregates all of the predicted individual EV charging amounts and all of the predicted individual EV discharging amounts and computes the difference between the aggregated EV charging amount and the aggregated EV discharging amount based on the computation. At substep 254, the aggregated EVs charging and discharging predictor predicts EV charging amounts needed and available EV discharging amount. This step forecasts the aggregated EV charging needed at the site during the time interval. If the difference between the aggregated EV charging amount and the aggregated discharging amount is positive, then the EVs as a group will require power to charge overall, and if it is negative, the EVs will provide power to the site.

At step 260, energy optimization is performed at the site. At substep 262, based on the predicted aggregated EV charging and discharging amounts, energy trading between the DERs and the grid is optimized. At substep 264, based on the predicted aggregated EV charging and discharging amounts and the optimized energy trading, the energy management is optimized to increase the accuracy of the energy management control.

Accordingly, the EV charging and discharging prediction system in accordance with the disclosed concepts provides a solution to the technical problem of inaccurate forecasting EV charging and discharging at a site having EV charging capabilities due to, e.g., without limitation, stochastic arrival times of the EVs at the site by predicting the amount of EV charging and EV discharging that will occur during a given time interval (e.g., hours, a day, etc.) at that site. For example, collecting real time data (e.g., without limitation, the first leg of the trip covered so far, and optionally current and forecast traffic data) from a relevant EV in motion enables the EV charging and discharging prediction system to perform the trajectory and destination prediction, which can be modelled as a form of a plan recognition problem. The ability to perform the trajectory and destination prediction based on the real time data allows the EV charging and discharging prediction system to predict early and with an increased confidence whether the EV at issue will arrive at the site and the arrival time of the EV. Further, the amount of EV charging and discharging at the site during the time interval can be predicted from the historical data associated with the EV at issue. This prediction of the amount of EV charging and discharging can be enhanced based on weather and traffic data. For example, on a hot day, the EV will need more power for air conditioning, which in turn impacts the EV charging needed or the EV discharging available, depending on whether the EV at issue is predicted to perform charging or discharging at the site. Further, by collecting additional data about the EV user, the accuracy of the prediction can be further augmented. For instance, by utilizing the knowledge that the EV user plans to be in office the next day, which can be extracted from the EV user's calendar, communications or hot desk booking, increases the accuracy of the prediction that the EV at issue will arrive at the site and its arrival time. Therefore, by enabling accurate prediction of the arrival information including the arrival times, the EV charging and discharging prediction system removes or substantially decrease the uncertainties and stochasticity associated with the EV charging and discharging patterns, and thus provides accurate and reliable predictions of the EV charging and discharging at the site for a given time interval.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A computer-implemented method of predicting electric vehicle (EV) charging and discharging, the method comprising:
collecting input data from a database and a plurality of EVs authorized to be charged or discharged at a site, the input data including historical input data and real time input data associated with charging and discharging the EVs;
training a plurality of machine learning (ML) models using the historical input data to predict EV charging and discharging outcomes at the site for a time period; and
predicting, by an ML inference device that is applying the trained ML models to the real time input data, an amount of power needed for EV charging or an amount of EV discharging power available by the one or more authorized EVs during a time interval.

2. The method of claim 1, further comprising:
optimizing energy trading and energy management control based on the predicted amount of power needed for EV charging or the predicted amount of EV discharging power available by the one or more authorized EVs during the time interval.

3. The method of claim 1, wherein the training a plurality of ML models comprises:
training an arrival prediction model, using the historical input data, to predict that the one or more EVs are to arrive at the site during the time interval;
training an EV target capacity prediction model, using the input data and predicted arrivals of the one or more EVs, to predict EV target capacity at departure from the site for each of the one or more authorized EVs;
training an individual EV charging and discharging prediction model, using the input data and the predicted EV target capacity at departure for each of the one or more authorized EVs, to predict that the one or more authorized EVs each is to be charged or discharged at the site and predict corresponding amount of power needed for individual EV charging or corresponding amount of individual EV discharging power available to the site during the time interval; and
training an aggregated EV charging and discharging prediction model, using the input data and the predicted individual EV charging or discharging amount, to predict an overall EV charging amount needed or an overall EV discharging amount available by the one or more EVs during the time interval.

4. The method of claim 3, wherein the arrival prediction model comprises:
a trajectory prediction model structured to be trained to predict trajectories of the one or more EVs using a plan recognition technique that utilizes historical trip data including the trips made by the one or more authorized EVs in the past; and
an arrival time prediction model structured to be trained, using the historical data including roadmaps, traffic data and/or weather data, to predict the arrival time of the one or more EVs at the site.

5. The method of claim 3, wherein the EV target capacity prediction model comprises:
a return trip target capacity prediction model structured to be trained to predict the return trip target capacity of each of the one or more authorized EVs, using the historical input data including at least one of the site location, a return destination, historical charge usage data for a return trip home for each of the one or more authorized EVs, traffic data or weather data; and
a post-return-trip capacity prediction model structured to be trained, using the historical input data including at least one of the site location, the return destination, the historical charge usage data for a return trip home for each of the one or more authorized EVs, the traffic data or the weather data, to predict the post-return-trip capacity of each of the one or more EVs.

6. The method of claim 1, wherein the input data include EV data, roadmaps, traffic data, energy tariff data, load forecast data, onsite renewable generation forecast data, weather data, EV user data including EV user schedule data.

7. The method of claim 5, wherein the ML inference device comprises:
an arrival predictor structured to apply the trained arrival prediction model to the real time input data including EV data and EV user schedule data and predict that the one or more EVs are to arrive at the site during the time interval;
an EV target capacity predictor structured to apply the trained EV target capacity prediction model to the real time input data and predict EV target capacity at departure for each of the one or more authorized EVs;
an individual EV charging and discharging predictor structured to apply the trained individual EV charging and discharging prediction model to the real time input data and predict that the one or more authorized EVs each is to be charged or discharged at the site and predict corresponding amount of power needed for individual EV charging or corresponding amount of individual EV discharging power available to the site during the time interval; and
an aggregated EV charging and discharging predictor structured to apply the trained EV charging and discharging prediction model to the real time input data and to predict an overall EV charging amount needed or an overall EV discharging amount available by the one or more EVs during the time interval.

8. The method of claim 7, wherein the arrival predictor includes:
a trajectory predictor structured to apply the trained trajectory prediction model to the real time input data including a first leg of the current trip in progress and a roadmap, the first leg indicating the trajectory of each of the one or more authorized EVs from the inception of the trip to the current point in time, the trajectory predictor being further structured to determine that one or more authorized EVs are advancing towards the site and output a binary variable indicating the determination;
an arrival time predictor structured to apply the trained arrival time prediction model to the real time input data including at least one of the current location of each of the one or more authorized EVs, the site address, roadmap data, current and forecast traffic data, or current and forecast weather data, the arrival time predictor being further structured to predict arrival time of each of the one or more authorized EVs; and
an EV capacity-at-arrival predictor structured to apply the trained EV capacity-at-arrival prediction model to the real time input data and predict the EV capacity-at-arrival of each of the one or more authorized EVs, the EV capacity-at-arrival being a battery level of each of the one or more authorized EVs upon arriving at the site and indicated as a difference between the current battery level at the end of the first leg and estimated use of the EV battery during remaining trip to the site.

9. The method of claim 8, wherein the input data include a knowledge that the one or more authorized EVs is to arrive at the site at a future date, the knowledge being extracted from calendars, communications or desk booking data of respective EV users, wherein the knowledge increases the accuracy of the predicted arrivals and the predicted arrival times of the one or more authorized EVs.

10. The method of claim 8, wherein the EV target capacity predictor comprises:
a return trip target capacity predictor structured to apply the trained return trip target capacity prediction model to the real time data including at least one of the site location, the return destination, current and forecast weather data or current and forecast traffic data, the return trip targe capacity predictor being structured to predict the return trip target capacity of each of the one or more authorized EVs; and
a post-return-trip capacity predictor structured to apply the post-return-trip capacity prediction model to the real time data including at least one of the site location, the return destination, current and forecast weather data or current and forecast traffic data, the post-return-trip capacity predictor being further structured to predict post-return-trip capacity for each of the one or more authorized EVs.

11. The method of claim 3, wherein the ML inference device includes an EV charging and discharging predictor structured to apply the trained EV charging and discharging prediction model to the real time input data and predict the amount of power needed for EV charging or the amount of EV discharging power available by the one or more authorized EVs during the time interval.

12. The method of claim 11, wherein the EV charging and discharging predictor includes:
an individual EV charging and discharging predictor structured to apply the trained individual EV charging and discharging prediction model to the real time input data and corresponding historical data of each of the one or more authorized EVs, the individual EV charging and discharging predictor being further structured to predict amounts of power needed for individual EV charging or amounts of individual EV discharging power available to the site during the time interval; and
an aggregated EV charging and discharging predictor structured to apply the trained aggregated EV charging and discharging prediction model, aggregate the amounts of power needed for individual EV charging and the amounts of individual EV discharging power available, obtain a difference between the aggregated amount of power needed for EV charging and the aggregated amount of the EV discharging power, and predict an overall amount of power needed to charge the one or more EVs based on a positive value of the difference obtained.

13. An electric vehicle (EV) charging and discharging prediction system for use at a site having EV chargers and connected to databases and a cloud server hosting application programming interfaces (APIs) structured to ingest data from the databases and output input data, the system comprising:
a machine learning (ML) training device including ML models and a retraining device, the ML models structured to be trained using historical input data received from first APIs to perform EV charging and discharging prediction at the site for a time period, the retraining device structured to continuously retrain the trained ML models;
a model store structured to store at least the trained ML models;
an ML inference device structured to apply the trained ML models to real time data input received from the first APIs and predict that one or more authorized EVs are to arrive at the site for a time period and also predict an amount of EV charging power needed or an amount of EV discharging power available by the one or more authorized EVs for a time interval based on the real time input data and the historical input data; and
an insights data store structured to store insights derived from inferences, feed the insights to the ML training device for retraining, and transmit the insights to second APIs for optimization of energy trading and energy management control for the site.

14. The system of claim 13, wherein the energy trading and energy management control for the site is optimized based on the predicted amount of EV charging power needed or the predicted amount of EV discharging power available.

15. The system of claim 13, wherein the ML training device comprises:
an arrival prediction model including a trajectory prediction model structured to be trained to predict trajectories of the one or more EVs using a plan recognition technique and an arrival time prediction model structured to be trained using the historical input data including roadmaps, traffic data and/or weather data to predict the arrival times of the one or more EVs at the site;
an EV target capacity prediction model including a return trip target capacity prediction model structured to be trained to predict the return trip target capacity of each of the one or more authorized EVs using the historical input data and a post-return-trip capacity prediction model structured to be trained using the historical input data to predict the post-return-trip capacity of each of the one or more EVs;
an individual EV charging and discharging prediction model structured to be trained using the historical input data and the predicted EV target capacity at departure to predict that the one or more authorized EVs each is to be charged or discharged at the site and predict corresponding amount of power needed for individual EV charging or corresponding amount of individual EV discharging power available to the site during the time interval; and
an aggregated EV charging and discharging prediction model structured to be trained using the historical input data and the predicted individual EV charging or discharging amount to predict an overall EV charging amount needed or an overall EV discharging amount available by the one or more EVs during the time interval.

16. The system of claim 15, wherein the ML inference device comprises:
an arrival predictor structured to apply the trained arrival prediction model to the real time input data including the EV data and the EV user schedule data and predict that the one or more EVs are to arrive at the site during the time interval;
an EV target capacity predictor structured to apply the trained EV target capacity prediction model to the real time input data and predict EV target capacity at departure for each of the one or more authorized EVs;
an individual EV charging and discharging predictor structured to apply the trained individual EV charging and discharging prediction model to the real time input data and predict that the one or more authorized EVs is to be charged or discharged at the site and predict corresponding amount of power needed for individual EV charging or corresponding amount of individual EV discharging power available to the site during the time interval; and
an aggregated EV charging and discharging predictor structured to apply the trained EV charging and discharging prediction model to the real time input data and to predict an overall EV charging amount needed or an overall EV discharging amount available by the one or more EVs during the time interval.

17. The system of claim 16, wherein the arrival predictor includes:
a trajectory predictor structured to apply the trained trajectory prediction model to the real time input data including a first leg of the current trip in progress and a roadmap, the first leg indicating the trajectory of each of the one or more authorized EVs from the inception of the trip to the current point in time, the trajectory predictor being further structured to determine that one or more authorized EVs are advancing towards the site and output a binary variable indicating the determination;
an arrival time predictor structured to apply the trained arrival time prediction model to the real time input data including at least one of the current location of each of the one or more authorized EVs, the site address, roadmap data, current and forecast traffic data, or current and forecast weather data, the arrival time predictor being further structured to predict arrival time of each of the one or more authorized EVs; and
an EV capacity-at-arrival predictor structured to apply the trained EV capacity-at-arrival prediction model to the real time input data and predict the EV capacity-at-arrival of each of the one or more authorized EVs, the EV capacity-at-arrival being a battery level of each of the one or more authorized EVs upon arriving at the site and indicated as a difference between the current battery level at the end of the first leg and estimated use of the EV battery during remaining trip to the site.

18. The system of claim 17, wherein the EV target capacity predictor comprises:
a return trip target capacity predictor structured to apply the trained return trip target capacity prediction model to the real time data including at least one of the site location, the return destination, current and forecast weather data or current and forecast traffic data, the return trip targe capacity predictor being structured to predict the return trip target capacity of each of the one or more authorized EVs; and
a post-return-trip capacity predictor structured to apply the post-return-trip capacity prediction model to the real time data including at least one of the site location, the return destination, current and forecast weather data or current and forecast traffic data, the post-return-trip capacity predictor being further structured to predict post-return-trip capacity for each of the one or more authorized EVs.

19. The system of claim 18, wherein the ML inference device includes an EV charging and discharging predictor which includes:
an individual EV charging and discharging predictor structured to apply the trained individual EV charging and discharging prediction model to the real time input data and corresponding historical data of each of the one or more authorized EVs, the individual EV charging and discharging predictor being further structured to predict amounts of power needed for individual EV charging or amounts of individual EV discharging power available to the site during the time interval; and
an aggregated EV charging and discharging predictor structured to apply the trained aggregated EV charging and discharging prediction model, aggregate the amounts of power needed for individual EV charging and the amounts of individual EV discharging power available, obtain a difference between the aggregated amount of power needed for EV charging and the aggregated amount of the EV discharging power, and predict an overall amount of power needed to charge the one or more EVs based on a positive value of the difference obtained.

20. The system of claim 13, wherein the input data include a knowledge that the one or more authorized EVs is to arrive at the site at a future date, the knowledge being extracted from calendars, communications or desk booking data of respective EV users, wherein the knowledge increases the accuracy of the predicted arrivals and the predicted arrival times of the one or more authorized EVs.
